(19) United States
(12) Patent Application Publication
(10) Pub. No.: US 2004/0091622 A1
(43) Pub. Date: May 13, 2004

(54) Coated prepreg method and use

(76) Inventors: Karim B. Fernandes, Alta Loma, CA (US); Jeffrey T. Gotro, Trabuco Canyon, CA (US)

Correspondence Address: ROBERT D. FISH; RUTAN & TUCKER, LLP, P.O. BOX 1950, 611 ANTON BLVD., 14TH FLOOR, COSTA MESA, CA, 92628-1950, US

(21) Appl. No.: 10/656,500

(22) Filed: Sep. 4, 2003

Related U.S. Application Data
(60) Provisional application No. 60/408,394, filed on Sep. 4, 2002.
(60) Provisional application No. 60/408,421, filed on Sep. 4, 2002.

(51) Int. Cl. B05D 1/30

(52) U.S. Cl. 427/355; 427/420; 156/309.9

(57) ABSTRACT

A coated prepreg with high resin content and method of making such a prepreg, and a thermal dissipating printed circuit board and methods for manufacturing such a board. In particular, means to fill between circuit features with either a high Tg thermally enhanced dielectric or a non-thermally enhanced resin system.

This application claims the benefit of U.S. provisional application No. 60/408394 (Attorney Docket No. 100765.0002PRO) filed on Sep. 4, 2002 and titled “Method for Making a Prepreg and Using It in Printed Circuit Boards with Heavy Copper Internal Planes”, and the benefit of U.S. provisional application No. 60/408421 (Attorney Docket No. 100765.0003PRO) filed on Sep. 4, 2002 and titled “Method for Making Enhanced Thermal Conductivity Resin Film and Prepreg”, each of which is incorporated herein by reference in its entirety.

### FIELD OF THE INVENTION

The present invention relates to methods for making a partially cured, solventless, reinforced thermosetting polymer film(called a prepreg), and more particularly relates to methods for making partially cured, solventless, reinforced thermosetting polymer films having high resin content used to fabricate printed circuit boards with heavy copper internal planes. Additionally, the methods described herein relate to a B-staged prepreg coated with a thermally enhanced, partially cured, solventless resin. The reinforced polymer films are used improve the thermal performance of multilayer printed circuit boards. Improving the thermal performance of the printed circuit board is an important design parameter in the packaging of power supply products and other electronic components that generate a large amount of heat during standard operation.

### BACKGROUND OF THE INVENTION

The current state-of-the-art for manufacturing partially cured, reinforced thermosetting polymer prepregs involves coating a reinforcement (woven glass cloth, non-woven glass cloth, non-woven organic fiber papers) with a resin solution consisting of thermosetting resins and high vapor pressure solvents.

Traditional prepregs for printed circuit boards are manufactured by coating woven glass cloth with a solvent-based resin system. The resin systems are typically epoxy resins or high-performance epoxy resins. Other resins such as cyanate esters, phenolics, novolacs, and polyimides can also be used. During the impregnation process, the woven glass cloth must be immersed into the liquid epoxy to thoroughly coat the cloth allowing the resin to penetrate into the glass cloth bundles. The next step is to evaporate the solvent from the moving web. After the solvent is removed, additional heat is applied to the moving web to cause a chemical reaction to take place. Chemical bonds form (crosslinking reactions) causing the molecular weight and the viscosity to increase. The temperature and time at temperature are carefully controlled to enable only a partial curing to occur. Not all of the reactive groups are allowed to react in the treating process. The partial curing is termed B-staging. Unreacted resin is termed A-staged, partially cured prepreg is termed B-staged, and fully cured resins are termed C-staged.

As an example in FIG. 1, a roll of woven fiberglass 1 is loaded onto the front end of the treater. The fiberglass is carried over a series of rollers to a dip pan 2 containing a solvent-based resin solution. The fiberglass cloth is saturated by the resin solution in the dip pan 2 making sure the fiberglass is completely coated. The resin content is controlled by counter-rotating metering rolls 3. The coated fiberglass web enters a controlled temperature oven. In the first part of the oven 4 solvent is carefully removed. In the second zone of the oven 5, the remaining solvents (typically high boiling solvents) are removed. The web then enters two additional heated zones 6, 7 to partially react (B-stage) the resin. The coated fiberglass emerges from the oven as a tack-free, B-staged prepreg. The prepreg can be rolled onto a wind-up station 8 or run through a sheet cutter 9 to cut the panels into the appropriate sheets 10.

Solvent-based impregnation methods can cause several detrimental problems during the treating operation. Solvent evaporation leads to voids in the prepreg. If these voids are not eliminated during the lamination of the circuit board, reliability failures (high potential dielectric breakdown failures, or hipot fails) could occur leading to circuit board performance degradation. Solvent evaporation during the treating operation causes the ratio of the resin to solvent (% solids) to change, potentially leading to difficulties controlling the amount of resin applied to the reinforcement. The solvent vapors are collected, incinerated, and scrubbed prior to emission into the atmosphere. Incineration and scrubbing equipment is costly to purchase and maintain. The process also requires expensive environmental permitting.

Typical epoxy-based prepregs and laminates have approximately 0.5-1.0 W/m° K thermal conductivities. When used in typical multilayer printed circuit boards, these materials have limited ability to dissipate heat or provide thermal spreading. Increasing the thermal conductivity of the epoxy-based prepreg will improve the thermal performance of printed circuit boards.

Circuit board designers incorporate heavy copper planes in multilayer printed circuit boards to decrease the heat build-up under hot devices. Heavy copper planes increase the thermal spreading and decrease hot spots under active devices. The thicker the copper planes, the more difficult it is to encapsulate the circuit traces during multilayer board fabrication. Traditional prepregs do not have enough resin to adequately fill between the circuit traces. A need exists for a prepreg with very high resin content.

Multilayer circuit board fabrication involves building a structure containing two or more layers of patterned conductive sheets (typically copper) insulated by a polymeric dielectric. The dielectric is typically a high performance fiberglass reinforced epoxy resin. The first step involves the circuitization of copper clad laminate cores using well-established lithographic techniques (print and etch). The laminate cores are fully cured (C-staged) fiber reinforced resin covered with a copper foil. The thickness of the core and thickness of the copper can be tailored for the particular type of circuit board.

Multilayer boards are made by placing B-staged prepreg (partially cured epoxy resin impregnated into a woven fiberglass fabric) between the circuitized cores and laminating the stack-up using heat and pressure. The B-staged prepreg serves two purposes; first, as a source of resin to flow into and between the circuit traces and secondly, as an adhesive to bond the circuitized cores together. Multilayer boards can have 4 layers to greater than 40 layers of circuitry. The process is similar regardless of the number of layers.

As an example, FIG. 2A is a perspective view of a typical printed circuit board 11 with external wiring lines 14 and embedded power/ground (or voltage) planes 12. Interconnections are made from front to back and to internal planes by means of plated-through-holes (PTH) 13. The plated-through-holes are spaced apart by the grid spacing 15 to allow for the wiring lines to pass in between. The wiring lines make connections to the edge of the board by means of pads 16.

The multilayer structure in FIG. 2a may be fabricated by a layup process and subsequent lamination under heat and pressure using a prescribed heating rate and pressure profile. As shown in FIG. 2b, the lamination “layup” consists of external copper layers 17. Layers 17 are circuitized into the external wiring lines after lamination, drilling, and plating. The internal power/ground planes 12 are circuitized using standard lithographic methods. The power/ground core 12 is typically made using FR-4 epoxy laminate cores and may contain copper in thickness ranging from 0.0005″ (½ oz) to 0.014″ or greater. A dielectric layer (called a prepreg) 18 is used to insulate the power/ground 12 planes from the circuit traces. Additionally, the prepreg layer 18 is used to provide resin to fill into the spaces in the power/ground plane 12. During lamination, the prepreg layer 18 softens and flows, resulting in a fully consolidated, high performance laminate.

The B-stage prepreg acts as a fill material in that, during the lamination process, it softens, flows, and fills in between the circuit features. The key to the lamination process is that the B-staged prepreg contains enough resin to flow and encapsulate all of the circuit traces. If the resin content is too low, or the lamination process is not optimized, voids can occur in the final product. The lamination process also causes the thermosetting polymer to fully cure leading to a solid high performance multilayer structure. When standard copper thicknesses are used (typical thickness is in the range of 0.0005″ to 0.004″) the lamination process can be optimized to provide adequate flow and resin to fill the core.

For special applications requiring the dissipation of large amounts of heat for an electronic component (for example a power supply), the multilayer printed circuit board incorporates power/ground planes with increased copper thickness. The increased thickness provides an enhanced path for heat spreading and dissipation. The copper thickness in standard circuit boards is in the range of ½ ounce to 2 ounce (0.0007-0.0028″). For copper thickness up to 0.004″, the standard lamination method is generally adequate to fill between the traces without forming voids and does not significantly increase the spacing between the power/ground layers and signal layers.

Voids are very detrimental to the functionality of the circuit board due to the propensity to form shorts after subsequent processing (such as drilling and plating to form interconnecting vias). When the copper thickness increases to greater than 0.004,″ it becomes increasingly difficult to laminate enough resin into the cavities between the traces using standard prepregs. One method to fill the cavities in thick copper planes is to use multiply plies of prepreg with high resin content. While this may lead to adequate filling of the circuit features, using multiple prepreg sheets causes an increase in the dielectric spacing and an undesirable increase in the overall circuit board thickness. Additionally, the addition of prepreg causes degradation in the thermal performance, since the dielectric is an insulating material. Due to the large and deep areas that require filling, it is likely that voids form in the filled areas. During conventional lamination, the large amount of resin flow required to fill into the spaces between the traces may also lead to thickness variations across the circuit board.

Unfortunately, known methods are generally insufficient to provide for fully cured void-free resin between all circuit traces on a 0.004″ (or higher) copper etched power/ground core and thus insufficient to allow thicker copper power/ground planes that would enhance the heat spreading ability of the multilayer structure.

The current invention describes a method to make prepreg for use in multilayer printed circuit boards having heavy copper internal planes. Additionally, a method to make multilayer circuit boards with heavy copper internal planes is also described. The prepregs have a coating of a solventless, thermosetting polymer on one side of a previously B-staged epoxy-glass cloth prepreg. During lamination, the additional coating allows for void-free filling between the circuit traces. The prepregs and subsequent laminates made using the current invention have significantly improved thermal conductivities, allowing fabrication of a printed circuit board with improved heat spreading and thermal conduction of heat away from hot electronic components.

### SUMMARY OF THE INVENTION

The present invention is directed to a coated prepreg with high resin content and method of making such a prepreg. Additionally the present invention is directed to a thermal dissipating printed circuit board and methods for manufacturing such a board. In particular, means to fill between circuit features with either a high Tg thermally enhanced dielectric or a non-thermally enhanced resin system are disclosed. The resin systems are solventless (no organic solvents are used to dissolve the resin components) allowing the use of hot melt resin dispensing systems.

In the preferred embodiment, a solventless hot-melt resin system with high thermal conductivity (>2 W/m-° K) is applied to a prepreg by means of a slot die extrusion head. The resin system is heated in a hot-melt dispensing system, pumped into a precision machined manifold and extruded through a thin opening (slot die) onto the moving sheet of prepreg. The prepreg moves past the opening of the slot die allowing the dielectric material to flow and coat the surface of the moving prepreg. The volume of material dispensed onto the prepreg is controlled by the pump speed, the die width (slot width), and line speed. By optimizing these three control variables, a precise amount of dielectric can be placed on the prepreg. Additionally, a heated roller can be applied to the surface of the coated prepreg with slight pressure to achieve a uniform thickness of dielectric across the coated prepreg.

After the dielectric is applied and leveled, the moving web is passed through a heated oven to lower the viscosity allowing air bubbles to escape and causing the resin to partially cure (or B-stage). The resin does not need to be dried, as is the case for typical solvent-based B-stage resins, but additional curing will reduce the tackiness of the dielectric. The coated prepreg must not be tacky (or sticky) after the application of the dielectric since the prepreg needs to be handled and stacked in the lamination layup. The preferred embodiment uses an infrared (IR) heating source to heat the liquid resin system and cause a partial cure. Additionally, conventional hot air (forced convection) heating can be used to provide heating and curing of the resin.

In an additional embodiment, a solventless thermosetting resin the a thermal conductivity in the range of 0.2-1 W/m-° K can be coated onto the moving prepreg. This provides a lower cost solution for applications requiring lower cost at slightly lower thermal performance.

The purpose of coating the prepreg with additional resin is twofold. When building printed circuit boards with heavy copper internal planes, a large amount of resin is required to fill in between the circuit traces. Additionally, the dielectric spacing between the traces needs to be reduced.

The dielectric resin system will be fully cured (attain the final fully cured properties) during the subsequent lamination process used to incorporate the coated prepreg into the multilayer structure.

In the preferred embodiment, the coating resin consists of a solventless formulation of epoxy resins, curing agents, accelerators, and fillers. The epoxy resins provide the required physical properties. Additionally, thermosetting resins such as cyanate esters, and polyimides can also be utilized. The curing agent helps crosslink and forms the desired network structure and achieves the desired glass transition temperature (Tg). Fillers (typically boron nitride, aluminum oxide, aluminum nitride, or other similar high thermal conductivity, electrically insulating fillers) are incorporated into the thermosetting resin to improve the thermal conductivity. The use of solvents is avoided for both ease of handling, environmental, and worker safety concerns. Additionally, the resin system is flame retardant allowing a UL flammability rating of 94-V0. Resins used in multilayer printed circuit boards must achieve the UL flammability rating.

It is contemplated that the materials, devices, and methods disclosed herein will:

(a) provide multilayer circuit boards with enhanced heat spreading performance without increasing the overall board thickness;

(b) provide multilayer circuit boards incorporating heavy copper power/ground planes (greater than or equal to 2 ounce copper) without increasing the overall board thickness, leading to enhanced ability of the board to dissipate and conduct heat away from components mounted on the circuit board;

(c) provide multilayer circuit boards with reduced dielectric spacing between the heavy copper power/ground planes, leading to a multilayer circuit board with decreased overall thickness and improved thermal spreading and thermal conductivity;

(d) provide multilayer circuit boards with increased resistance to direct current (DC) dielectric breakdown (HIPOT testing); and

(e) provide a means to manufacture a void-free multilayer printed circuit board.

Various objects, features, aspects and advantages of the present invention will become more apparent from the following detailed description of preferred embodiments of the invention, along with the accompanying drawings in which like numerals represent like components.

### BRIEF DESCRIPTION OF THE DRAWINGS

FIG. 1a shows typical solvent impregnation system to make B-staged prepreg (prior art)

FIG. 2a. shows a typical multilayer printed circuit board with two internal power/ground (prior art)

FIG. 2b shows the multilayer stack-up prior to lamination for the typical multilayer circuit board shown in FIG. 1a (prior art).

FIG. 3 is a schematic of a method to make coated high resin content prepreg.

FIG. 4 shows the solventless prepreg coating line

FIG. 5 shows a typical product showing release liners, coating, and prepreg

FIG. 6 is a schematic of the method to make a multilayer printed circuit board with heavy copper internal planes

FIG. 7 shows the layup prior to lamination

FIG. 8 shows a schematic of cross-section of typical laminate after lamination and fully curing.

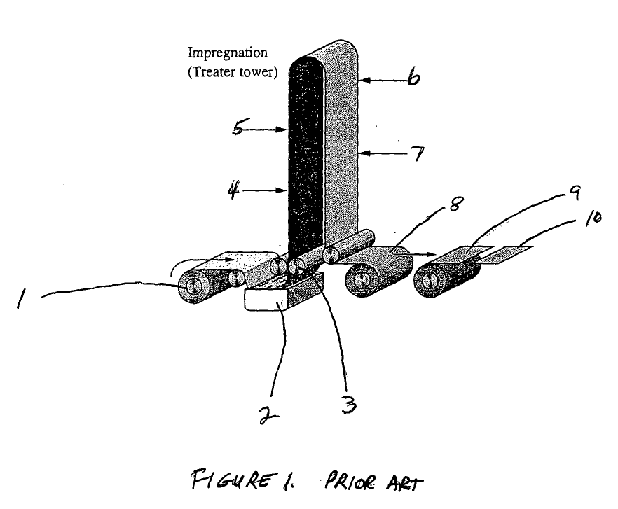

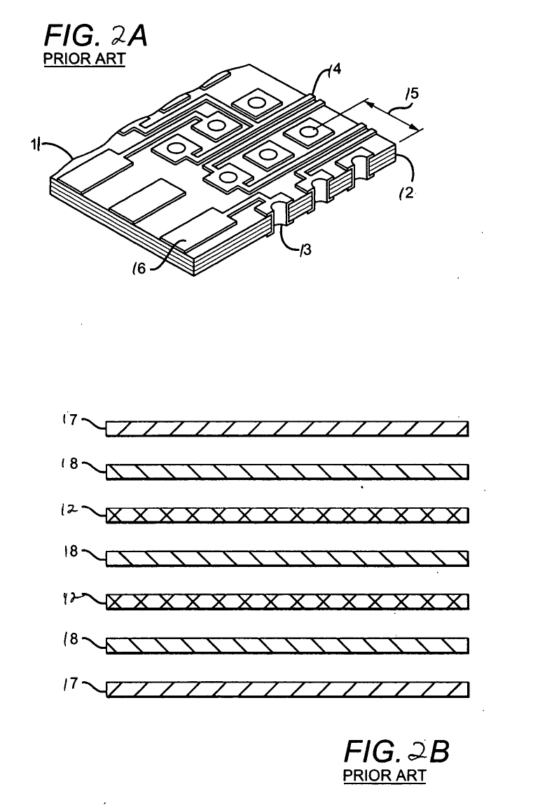

### DETAILED DESCRIPTION

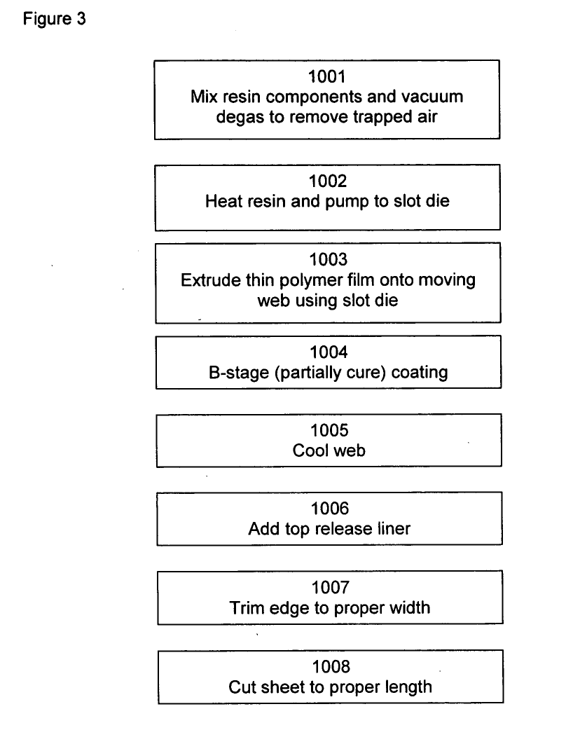

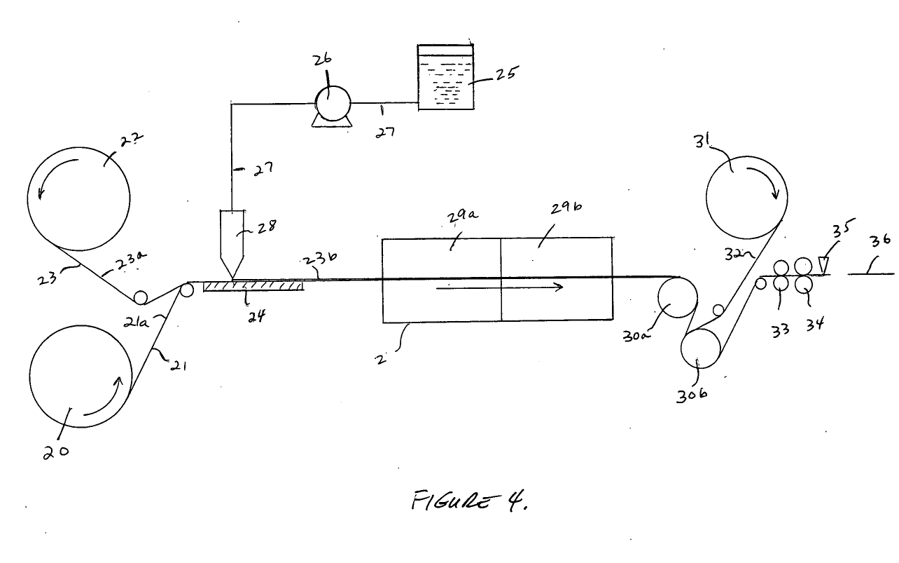

Referring to FIG. 3, a coated prepreg may be formed by process 1000 comprising the following; step 1001, mix resin components at controlled temperatures and apply vacuum to degas molten resin; step 1002, pump heated resin to slot die; step 1003, extrude thin coating of resin onto moving prepreg; step 1004, B-stage (partially cure) the coating; step 1005, cool the moving web; step 1006, apply a top release liner onto top surface of coated prepreg; step 1007, trim edge to desired dimension; step 1008, trim length to desired dimension resulting in properly sized sheet.

In FIG. 4, the process starts with an unwind station 20 for the lower release liner. The release liner 21 is coated on a first surface 21a with a silicone polymer coating to prevent the prepreg from sticking to the surface of the release liner. An unwind station 22 feeds a continuous roll of prepreg 23 and places the prepreg sheet in contact with the coated first surface 21a of the release liner. The release liner and prepreg sandwich are run over a temperature controlled heated/cooled table 24. The prepreg is partially cured, (B-staged) thermosetting resin that has been impregnated into a woven glass cloth. The glass cloth is typically thin glass cloth comprising the common styles of 104, 106, 6060, 1080, and 2116. The coating system consists of a reservoir to contain the solventless hot melt resin system and a temperature controlled transfer hose 27. The top surface 23a of the prepreg is passed under the slot die extrusion head 28. Here a uniform coating of the solventless resin is placed on the top surface 23a of the prepreg. The resin coating thickness is controlled by the pump speed, the resin temperature, the pump pressure, and the line speed of the moving release liner.

After the top surface 23a is coated with a precise thickness of the solventless thermosetting resin 23b, the web enters a temperature controlled oven 29 to partially cure the resin coating. The oven has two independently controlled temperature zones, 29a and 29b. The temperature profile is programmed to increase the temperature of the moving web as it travels through the oven. The controlled temperature ramp ensures a uniform, consistent curing and B-staging. After the prepreg emerges from the B-stage oven 29a and 29b, the web passes over a set of chill rolls 30. The chill rolls are temperature controlled using chilled water circulating through the core of each roller. The chill rolls 30a and 30b are adjustable to increase or decrease the wrap angle. The larger the wrap angle on rolls 30a and 30b, the more time the moving web is in contact with the cold surface of the roller, thus decreasing the temperature of the web. An unwind station 31 feeds a release liner 32 to protect the top surface of the coated prepreg. The release liner is introduced between chill roll 30a and 30b. The web is pulled through the entire system using a pair of pull rolls 33 near the end of the line. The top release liner 32 protects the coated surface from friction or damage induced by the pull rolls. The web is now cut to the desired width using on-line knife 34. The length dimension is cut using an in-line blade 35 that makes a cut to the final length dimension. The end result is a sheet 36 with the desired size (length and width).

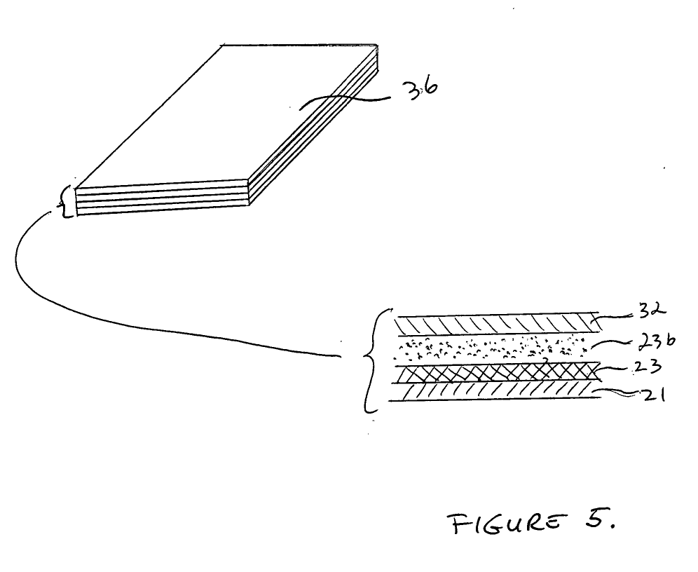

In FIG. 5, the completed multilayer sheet 36 is shown in more detail. The structure consists of the lower release liner 21, with the thermosetting resin glass cloth prepreg 23, the solventless thermosetting polymer coating 23b, and the top release sheet 32. The release sheets 21 and 32 will act as protective covers for the completed sheet 36.

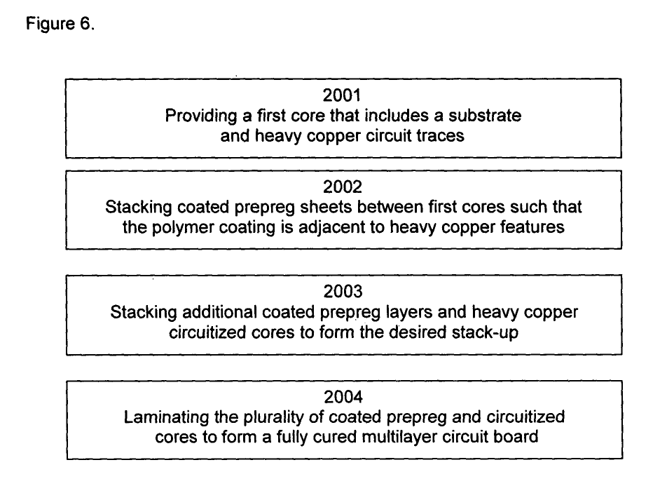

The coated prepreg described above is used to build multilayer thermally enhanced printed circuit boards. Referring to FIG. 6, a multilayer printed circuit board may be formed by process 2000 comprising the following; step 2001, providing a first core that includes a substrate and heavy copper circuit traces; step 2002, applying two coated prepreg layers between two heavy copper cores such that the coated layer is in contact with the adjacent heavy copper cores; step 2003, stacking additional coated prepreg and circuitized cores to form the desired geometry; step 2004, laminating the plurality of coated prepreg and circuitized cores to form a multilayer circuit board.

The phrase “heavy copper” as used indicated copper having a thickness of at least 3 mils (0.003″). The phrase “void free” is used to indicate that there are no visible voids having a diameter larger than 5 microns.

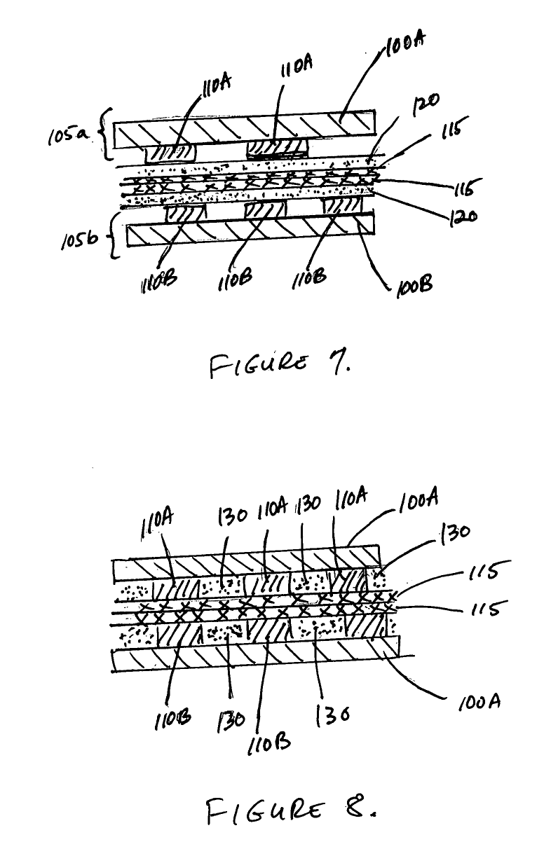

In FIG. 7, the circuitized cores 105a and 105b consist of a fully cured thermosetting resin and glass cloth laminate 100a and 100b with copper circuit traces 110a and 110b on each side of the laminate. Prior to layup, the top release liner 33 is removed exposing the partially cured thermosetting resin coating 120 on the first surface of the B-staged woven-glass cloth epoxy prepreg 115. The coated side is placed over the circuit traces 110a and 110b. The purpose of the coating on the prepreg is to flow into the cavities created by the heavy copper circuit traces 110a and 110b. During lamination, the partially cured B-stage coating, softens and flows. The lamination heating rate, press temperature, and pressure are precisely controlled to yield a completely filled, void free, consolidated and fully cured structure.

In FIG. 8, a schematic cross section is shown depicting the final structure. The spaces between the heavy copper circuit traces 110a and 110b are filled with completely cured, void free thermosetting resin 130. The dielectric spacing (the distance between the top surfaces of circuit traces 110a and 110b) is controlled by the thickness of the prepreg 115. The coating thickness 23b (in FIG. 5) is tailored to completely fill between the circuit traces 110a and 110b depending on the thickness of the copper trace. The coating thickness increases as the copper thickness increases, since there is a larger volume of material required to completely fill between the traces 110a and 110b.

After lamination, traces 110a and 110b are separated at least by the two layers of cured prepreg. The amount of spacing between traces 110a and 110b is termed the “dielectric spacing.” The final structure depicted in FIG. 8 is fully cured.

It is also preferred that, while minimizing the dielectric spacing, the dielectric material separating traces 110a and 110b (i.e. any portion of resin 130 covering traces 110a and/or 110b along with dielectric layers 115) has a thermal conductivity greater than or equal to 5 W/m-° K, and a dielectric breakdown voltage of at least 1500 V/mil. Although the amount of dielectric spacing will vary at least in part based on the thickness of traces 110a and 110b, and on the type of materials used for resin 130 and layer 115, the multilayer circuit board can be characterized by the ratio of copper thickness to the dielectric spacing between the traces 110a and 110b. Using previously known methods that ratio would generally be far less than 1 (i.e. the dielectric spacing is usually substantially greater than the copper thickness). For the disclosed board and methods, that ratio will be at least 1 (i.e. the dielectric spacing will be less than or equal to the copper thickness.) For convenience, that ratio will be referred to herein as the thickness-separation (“TS”) ratio.

It is contemplated that a benefit of using the method described above is that it makes possible the formation substantially void free encapsulated heavy copper cores, the use of which, in turn, makes possible the formation of multi-layer circuit boards wherein the ratio of copper thickness to the dielectric spacing (“TS” ratio) between the heavy copper planes is at least 1.4 while maintaining the preferred core thermal conductivity and dielectric breakdown voltage. Having a “TS” ratio greater than 1.4 allows for greater thermal dissipation without having to increase the multilayer board thickness substantially.

Thus, specific embodiments and applications of coated prepregs methods have been disclosed. It should be apparent, however, to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced.

What is claimed is:

1. A method for forming a coated prepreg comprising applying a solventless hot-melt resin system with high thermal conductivity (>2 W/m-°K) to a prepreg by means of a slot die extrusion head.

2. The method of claim 1 further comprising:
heating the resin system a hot-melt dispensing system;
pumping the resin system into a precision machined manifold;
extruding the resin system through a thin opening (slot die) in the manifold and onto the prepreg while controlling the relative movement between the manifold and the prepreg such that the prepreg moves past the opening of the slot die in a manner allowing the dielectric material to flow and coat the surface of the moving prepreg while the volume of material dispensed onto the prepreg is controlled by the pump speed, the die width (slot width), and line speed to place a precise amount of dielectric resin on the prepreg.

3. The method of claim 2 wherein a heated roller is applied to the surface of the coated prepreg formed by the extruded dielectric with slight pressure to achieve a uniform thickness of dielectric across the coated prepreg.

4. The method of claim 2 wherein, after the dielectric is applied and leveled, the moving web is passed through a heated oven to lower the viscosity at least in part by allowing air bubbles to escape and causing the resin to partially cure.

5. The method of claim 4 comprising additional curing without air drying to reduce the tackiness of the dielectric.

6. The method of claim 5 wherein the coated prepreg is subsequently stacked stacked in a lamination layup.

7. The method of claim 2 wherein an infrared (IR) heating source and/or a hot air source is used to heat the liquid resin system and cause a partial cure.

8. The method of claim 2 wherein the resin system is a solventless thermosetting resin the has a thermal conductivity in the range of 0.2-1 W/m-°K.

9. The method of claim 2 wherein the resin system is not fully cured until it is included in a subsequent lamination process used to incorporate the coated prepreg into a multilayer structure.

10. The method of claim 2 wherein coating resin consists of a solventless formulation of epoxy resins, curing agents, accelerators, and fillers.

11. The method of claim 2 wherein the coating resin is a thermosetting resins.

12. The method of claim 11 wherein the coating resin is a cyanate ester or a polyimide.

13. The method of claim 2 wherein a curing agent is used to help crosslink and form the desired network structure to achieves a desired glass transition temperature (Tg).

14. A method of forming multilayer circuit boards with enhanced heat spreading performance without increasing the overall board thickness.

15. A prepreg formed according to the method of claim 1.

16. A multilayer circuit board comprising the prepreg of claim 15.
